(19) United States
(12) Patent Application Publication
(10) Pub. No.: US 2011/0248847 A1
(43) Pub. Date: Oct. 13, 2011

(54) MOBILE ASSET LOCATION IN STRUCTURE

(75) Inventors: Steve D. Huseth, Plymouth, MN (US); Tom Plocher, Hugo, MN (US)

(73) Assignee: Honeywell International Inc., Morristown, NJ (US)

(21) Appl. No.: 12/756,557

(22) Filed: Apr. 8, 2010

(51) Int. Cl. G08B 1/08

(52) U.S. Cl. 340/539.13

(57) ABSTRACT

A system and method are used to determine at least two distances to a mobile asset in a structure from first and second anchor transceivers placed a known distance from each other. A view of the structure is created as a function of a location corresponding to the two anchor transceivers. A representation of the mobile asset is included in the view of the structure.

### BACKGROUND

A number of person and asset location tracking technologies have been developed and are emerging in the market space (e.g. GPS systems, cell phone tracking, building asset tracking). Virtually all current systems assume the existence of a building/structure map on which the tracks and locations can be shown on a display to the user. But this ignores the more usual case in which the structure of interest has no map or floorplan. Houses are a good example, almost never having a floorplan readily available to emergency services. Assets may simply be shown in open space on a display device with no boundaries or context. When information regarding a structure is available, it may be shown in some systems in relation to the assets being tracked. It can be difficult to utilize the view shown to effectively make asset deployment decisions.

The user may become spatially confused about the scene and make errors of judgment about the locations of the people inside the structure and what to do about them.

### SUMMARY

A system and method are used to determine at least two distances to a mobile asset in a structure from first and second anchor transceivers placed a known distance from each other. A view of the structure is created as a function of a location corresponding to the two anchor transceivers. A representation of the mobile asset is included in the view of the structure.

### BRIEF DESCRIPTION OF THE DRAWINGS

FIG. 1 is a block diagram of a system for locating mobile assets within a structure and providing a user centric display of the structure according to an example embodiment.

FIG. 2 is a representation of the display of the structure according to an example embodiment.

FIG. 3 is a representation of calculations used to identify the location of a mobile asset within a structure according to an example embodiment.

FIG. 4 is a simple flow chart representation of a process for displaying a mobile asset in a user centric view of a structure according to an example embodiment.

FIG. 5 is a block diagram of a computer system for performing methods and calculations according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Tracking systems for on site in mobile asset deployment situations, such as fire fighting and military operations are described that use relative location from a known starting point to display deployed assets in a context and orientation that can be effectively understood. A user is provided with a display that facilitates instant understanding of the locations of the people being tracked in a structure relative to his or her own location outside the structure. The display provides a view that allows them to comprehend the assets and locations from their own perspective view of the structure and scene. The user may also easily understand the locations of the people being tracked in the context of the structure in which those people are moving. In some embodiments, a structure may include a building, a compound of multiple buildings, a particular landscape, or other combination of buildings and landscape.

In some embodiments, an emergency incident commander is able to directly view the incident site from his or her command vehicle and use that view to gain context into changes in the emergency situation. Using high performance ranging radios mounted on the command vehicle, a precise range and bearing from the vehicle to the fire fighters in the building may be determined. Using the bearing measurements, a display is synthesized for the incident commander.

In further embodiments, the view it may be augmented with graphical objects such as smoke sensors and graphical depictions of temperature gradients, smoke and noxious gas flows, oxygen depletion, etc. Also the view may be displayed in a 3D graphics viewer equipped with tools to enhance the view, such as tools to zoom, pan, and rotate the building structure shown in the view, change the transparency of building structures, and perform other manipulations to reduce structural occlusion of objects of interest such as the mobile assets or other graphical objects described above.

With the likely lack of a structure map, particularly for house fires, a “shell” or wireframe depiction of the structure may be constructed and registered accurately around the locations of the people inside it who are being tracked. In some embodiments, pre-existing maps or floorplans may provide a depiction of the structure. Lacking those, at least a 2D footprint of the house or perhaps even an approximate 3D wireframe or simple “box” from may be extracted from GoogleEarth/GIS data. Structure discovery, using historical tracking data, may also be used to generate a crude structural shell.

A further flaw of current location systems is that the display shows the structure and tracks inside it from perspectives totally unrelated to those of the user sitting outside the building. In some embodiments, the display may be relative to where the command vehicle is located. This allows an essentially synthetic vision capability in which a display presents information as though the commander was looking out the window of the vehicle, e.g. from exactly the same perspective. Such a display may also be referred to as an “egocentric” display of the structure to show tracks/locations meaningfully, the “ego” part being “from the location and viewing perspective of the incident commander as he observes the structure from his command vehicle.”

Impulse UWB and multicarrier UWB radios have been constructed that provide a high degree of ranging precision to an object being tracked. Using the ranging information from 2 or more antennas with a fixed, known separation on each end of the vehicle allows the creation of an angle measurement through simple trigonometry. This angle measurement and distance to one or more fire fighters can be used to create displays from the command vehicle perspective.

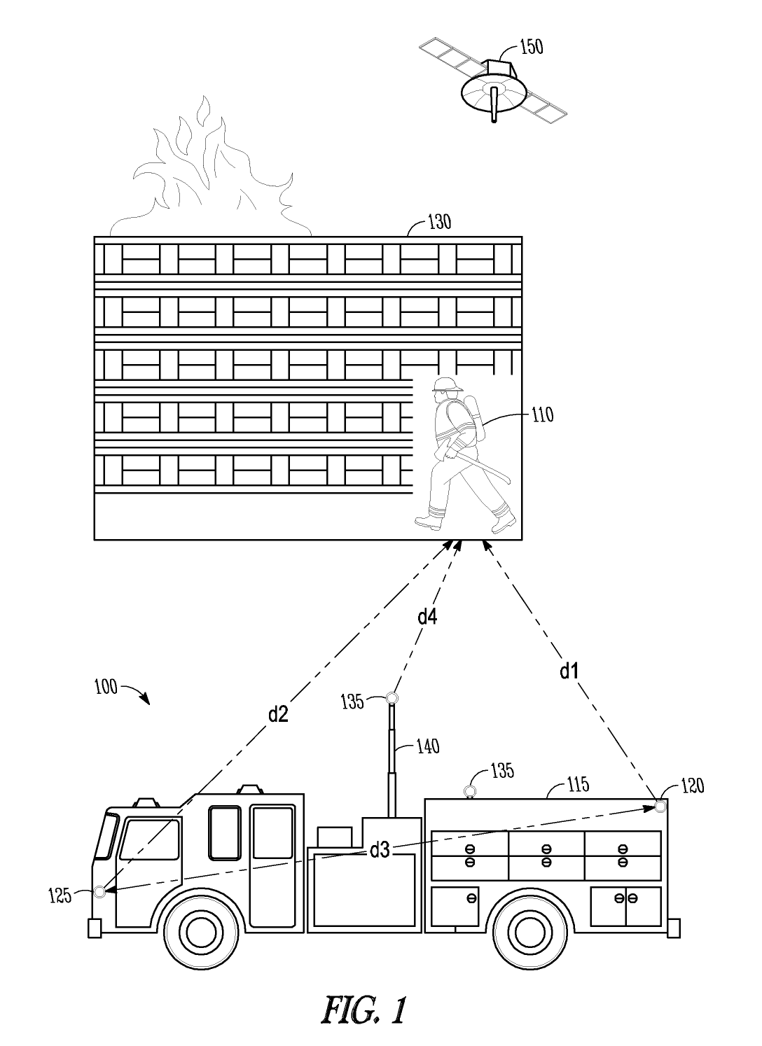

FIG. 1 is a block diagram illustration of a system 100 for detecting an asset 110, such as a fire fighter, or other asset having a transceiver. FIG. 1 is drawn as just one example in which system 100 may be deployed. In one embodiment, a vehicle 115 has at least two anchor transceivers 120, 125 mounted on the vehicle a fixed and known distance, d3, from each other. In one embodiment, the vehicle 115 may include any type of vehicle, such as a fire truck, emergency response vehicle, military vehicle, or even some type of mechanical structure providing a fixed distance relationship between the anchor transceivers. In still further embodiments, the transceivers may be standalone wireless devices having sensors for precisely determining a distance between themselves. Such wireless devices may be simply placed a suitable distance from the structure and networked to a computer system for processing data.

Each of the anchor transceivers 120, 125 may be used to determine their respective distances, d1, d2 from the asset 110, such as by using time of flight measurements. With the three distances, d1, d2, and d3, all three sides of a triangle are known, and the location of the asset may be precisely known in a horizontal plane. In one embodiment, the anchors 120, 125 may be manufactured into the vehicle, and reside in a same horizontal plane.

If a structure 130 has multiple levels, a third anchor transceiver 135 may be used to determine a fourth distance, d4. The third anchor transceiver 135 in one embodiment is located on a different vertical level than the first and second anchor transceivers to provide the ability to identify a height of the asset with respect to the height of the first two anchors. In one embodiment, the third anchor transceiver 135 may be mounted on a pole, such as a telescoping pole 140 to obtain a desired vertical offset from the other two transceivers. Transceivers 120, 125 may be mounted in the same horizontal plane, or may also be vertically offset from each other. In some embodiments, the three transceivers should not be mounted in a straight line from each other, as a third dimension of position may be lost. The distances, and vertical and horizontal offsets from each of the anchor transceivers may be a function of the accuracy of the circuitry associated with such transceivers to determine time differences between transmissions and receipt of responses from the assets.

The distances to a structure 130 may also be determined from one or more sensors 140 on the vehicle 115. Sensors 140, such as laser ranging sensors, may also be co-located with one or more of the transceivers 120, 125, such that the distance is correlated with the distances to the asset 110. Further correlation may be obtained with the use of GPS devices incorporated into the anchor and asset transceivers. By knowing the relative positions of the structure 130, vehicle 115, anchors 120, 125, and one or more assets 110 within the structure, a display of the structure and relative position of the assets within the structure may be generated.

In still further embodiments, the location of the structure 130 may be identified by GPS on the assets and/or on the vehicle. A satellite 150 may be used to obtain views of the structure based on its location, such as via Google® Earth via a wireless network connection. Multiple top or footprint view and side views from the satellite and even from video taken from the vehicle or assets within the structure, may be used to construct a wireframe version of the structure for the display. Correlation of the view using the distance sensors may be done to align the images. Video from a camera image may be used to further augment the representation of the structure to still further provide a view that is easily understood by the user. In further embodiments, a user may be able to further augment the image of the structure with user observed information, such as the number of floors of the structure. Such information may also be derived from video images. In still further embodiments, if the floor plan is known, it may also be correlated and augmented with the data obtained from multiple sources.

Once the wireframe or other representation of the structure is created, it may be further augmented with information obtained from fire alarm sensors and other sensors within the structure. Such sensors may already be in the structure and networked, or may be placed by mobile assets, such as firefighters, and have their own transceivers, allowing them to be located by system 100. In still further embodiments, other assets, such as firefighting equipment may be outfitted with transceivers. Their locations inside and outside the structure may be identified and represented in a real time view, allowing better management of assets during emergency situations. This information will allow a user to better manage assets to fight fires and save lives, providing a situational awareness and allowing management from an ego centric position.

In still further embodiments, the view provided by the display may be presented in a manner that the user sees a view that is representative of the same perspective the user would have by looking directly at the structure. This minimizes potential confusion and translation of views that may otherwise be needed, leaving more time for the user to focus on accomplishing tasks that may be critical to the situation.

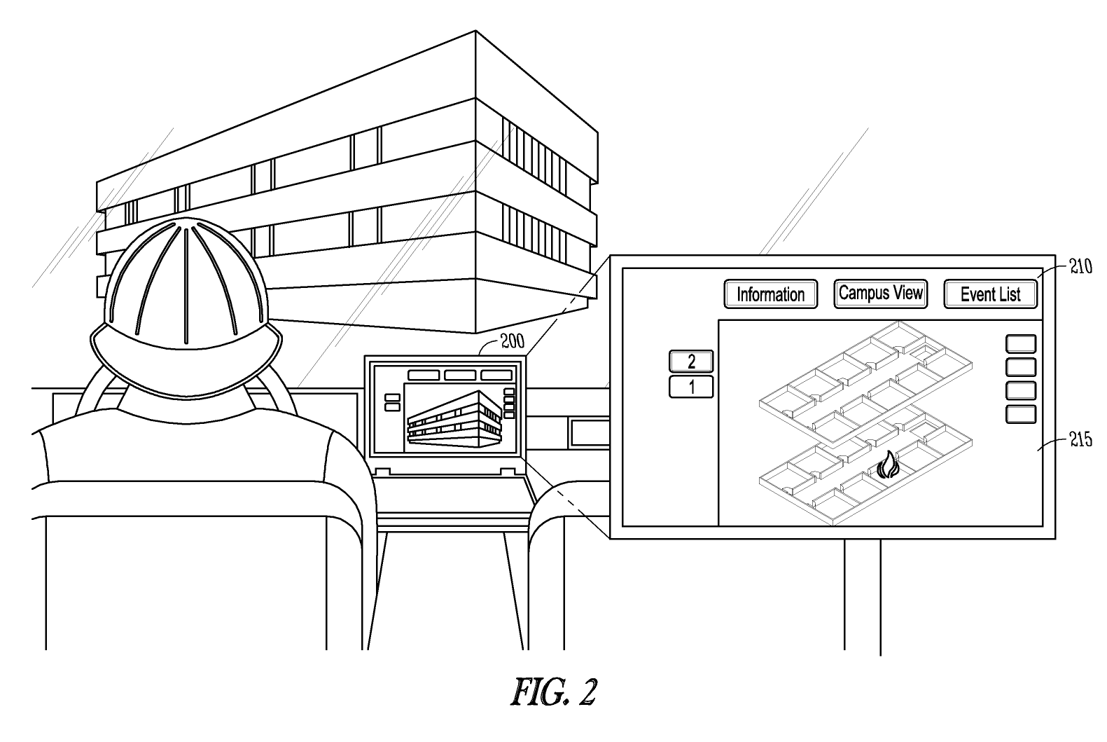

An example display is shown in FIG. 2 at 200. The display is mounted in one embodiment in a cab of a vehicle, such as vehicle 115, which may be pointed with its windshield providing a view of the actual structure. The display 200 in one embodiment is a laptop computer display, and as shown, provides the same perspective view of the structure as is visible out the windshield. Many different functions may be used to provide different views, such as an exploded view of each of the multiple levels in perspective as shown at insert 210. A mobile asset who's position has been calculated, is represented at 215.

In one embodiment, the display may be removed from the vehicle, while remaining connected such as via a wireless connection, to receive data from sensors located on the vehicle. The display may contain GPS functionality or other location sensing capability together with user orientation technology such as a magnitometer, allowing the view on the display to be adjusted to still maintain a display device or user centric view on the display. Viewing perspectives may be changed based on the known location and orientation of the user to maintain a display device or user centric view. In still further embodiments, a head mounted display may be used, with movements of the user's head tracked and the display updated as function of the head movement.

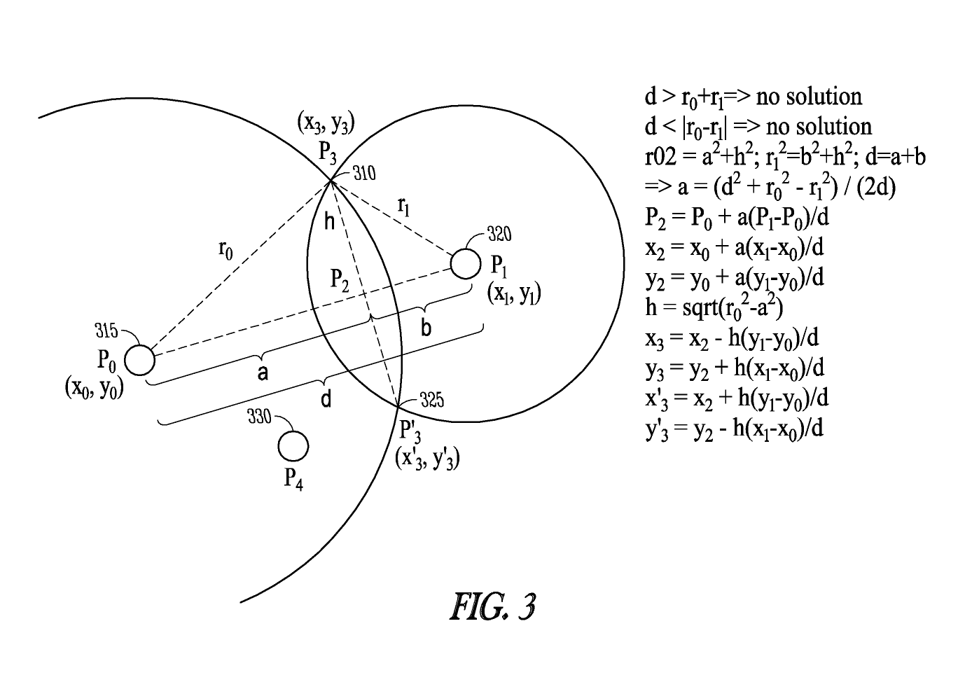

FIG. 3 illustrates calculations involved in determining the location of an asset, point P3 310 with x,y coordinates of x3,y3, given fixed points, corresponding to anchor points P0 315 and P1 320. As can be seen, unless it is assumed that all assets to be identified are on one side of the anchor points P0 and P1, there is a second point, P′3 325 at which the asset may be located. In one embodiment, yet a further anchor transceiver, P4 330 may be used to exactly determine which point, P3 or P′3 at which the asset is located. By ensuring that P4 330 is not on a same line with P0 315 and P1 320, the distances between the P4 330 anchor and points P3 310 or P′3 325 will be different, allowing one to be chosen as the correct location.

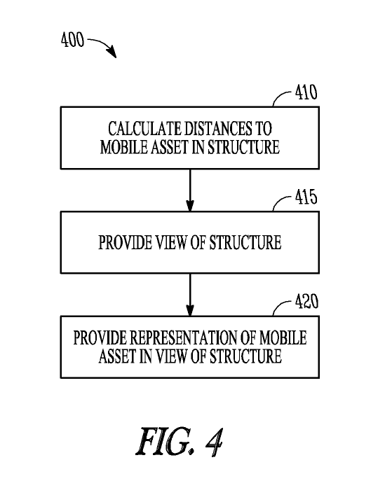

FIG. 4 is a flowchart illustrating a process 400 of determining a location of a mobile asset within a structure. At 410, at least two distances to a mobile asset in a structure are determined from first and second anchor transceivers placed a known distance from each other. At 415, a view of the structure is created as a function of a location corresponding to the two anchor transceivers. At 420, a representation of the mobile asset in the view of the structure is provided. In some embodiments, distances for multiple mobile assets are determined and representations of the multiple mobile assets are included in the view of the structure. The view may be a perspective box or wireframe structure view provided on a display device, and the structure may be oriented as a function of the location of the display device.

In one embodiment, the mobile asset includes a mobile transceiver to respond to communications from the first and second anchor transceivers. The distances may be calculated as a function of time of flight. Yet a further embodiment includes calculating a distance between a third anchor transceiver and the mobile asset to uniquely identify a direction in which the mobile asset is located. Also, a distance between an anchor transceiver that is vertically displaced from the first and second anchor transceivers and the mobile asset may be calculated to identify a vertical displacement of the mobile asset within the structure.

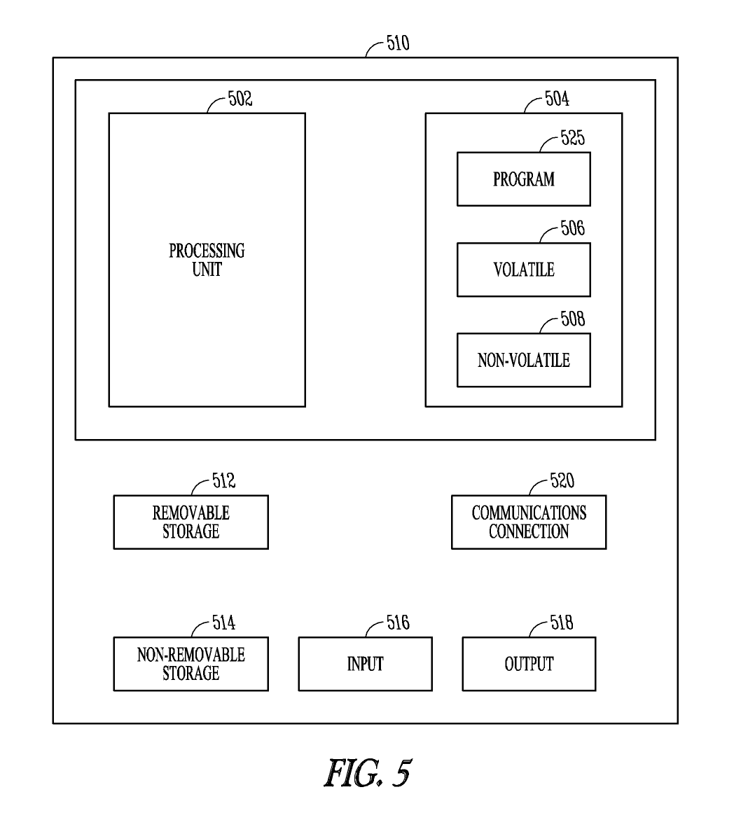

A block diagram of a computer system that executes programming for performing the above algorithm is shown in FIG. 5. A general computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions to execute methods and algorithms described above may be stored on a computer-readable medium such as illustrated at a program storage device 525 are executable by the processing unit 502 of the computer 510. A hard drive, CD-ROM, and RAM are some examples of articles including a computer-readable medium.

The Abstract is provided to comply with 37 C.F.R. § 1.72(b) is submitted with the understanding that it will not be used to interpret or limit the scope or meaning of the claims.

1. A method comprising:
determining at least two distances to a mobile asset in a structure from first and second anchor transceivers placed a known distance from each other;
creating a view of the structure as a function of a location corresponding to the two anchor transceivers; and
including a representation of the mobile asset in the view of the structure.

2. The method of claim 1 and further comprising determining distances for multiple mobile assets and including representations of the multiple mobile assets in the view of the structure.

3. The method of claim 1 wherein the distances are calculated as a function of time of flight.

4. The method of claim 3 wherein the mobile asset includes a mobile transceiver to respond to communications from the first and second anchor transceivers.

5. The method of claim 1 and further including calculating a distance between a third anchor transceiver and the mobile asset to uniquely identify a direction in which the mobile asset is located.

6. The method of claim 1 and further including calculating a distance between a third anchor transceiver that is vertically displaced from the first and second anchor transceivers and the mobile asset to identify a vertical displacement of the mobile asset within the structure.

7. The method of claim 1 wherein the view is a perspective view provided on a display device.

8. The method of claim 7 wherein the view of the structure is oriented as a function of the location of the display device to provide an ego centric view of the structure as the display device changes locations.

9. A system comprising:
a first anchor transceiver;
a second anchor transceiver; and
a display device coupled to receive a first distance of a mobile asset detected by the first anchor transceiver, a second distance of the mobile asset detected by the second anchor transceiver, a representation of a structure, and a distance between the first and second anchor transceiver to generate a display device centric view of the structure showing the mobile asset within the structure.

10. The system of claim 9 and further comprising a vehicle in which the first and second anchor transceivers are mounted a fixed distance from each other.

11. The system of claim 10 and further comprising a third anchor transceiver mounted on the vehicle a distance from the first and second anchor transceivers to provide a third distance to the mobile asset to uniquely identify the direction of the mobile asset from the vehicle.

12. The system of claim 10 and further comprising a vertically offset anchor transceiver mounted on the vehicle a known vertical distance from the first and second anchor transceivers to provide a vertical distance to the mobile asset to identify a vertical coordinate of the mobile asset with respect to the vehicle.

13. The system of claim 10 and further comprising at least one distance sensor mounted to determine a distance between the vehicle and the structure.

14. The system of claim 10 and further comprising a vertically offset anchor transceiver mounted on the vehicle a known vertical distance from the first and second anchor transceivers to provide a vertical distance to the mobile asset to identify a vertical coordinate of the mobile asset with respect to the vehicle.

15. The system of claim 9 wherein multiple mobile assets are shown in the view of the structure.

16. The system of claim 9 wherein the first and second distances are calculated as a function of time of flight.

17. A device readable medium having instruction stored thereon to cause a computer system to perform a method, the method comprising:
determining at least two distances to a mobile asset in a structure from first and second anchor transceivers placed a known distance from each other;
creating a view of a structure as a function of a location corresponding to the two anchor transceivers; and
including a representation of the mobile asset in the view of the structure.

18. The device readable medium of claim 17 and further comprising determining distances for multiple mobile assets and including representations of the multiple mobile assets in the view of the structure, and wherein the distances are calculated as a function of time of flight.

19. The device readable medium of claim 17 and further comprising:
calculating a distance between a third anchor transceiver to the mobile asset to uniquely identify a direction in which the mobile asset is located; and
calculating a distance between a vertically displaced anchor transceiver to the mobile asset to identify a vertical displacement of the mobile asset within the structure.

20. The device readable medium of claim 1 wherein the view is a perspective view provided on a display device, and wherein the view is display device centric.
